(19) United States
(12) Patent Application Publication
(10) Pub. No.: US 2004/0083457 A1
(43) Pub. Date: Apr. 29, 2004

(54) Methods and apparatus for program debugging using break states

(76) Inventor: Michael Boucher, Lafayette, CO (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/280,165

(22) Filed: Oct. 25, 2002

(51) Int. Cl. G06F 9/44

(52) U.S. Cl. 717/129; 717/124

(57) ABSTRACT

Methods and systems consistent with the present invention determine when multiple instances of a single program have reached a common break state, then initiate execution of a comparison of state information associated with the program instances. Thus, the methods and systems allow arbitrarily complex comparisons of indicators that reveal if a program instance is functioning correctly. A programmer is not limited by manual examination and review of program code. Rather, the methods and systems greatly facilitate debugging of complex programs.

### FIELD OF THE INVENTION

This invention relates to program debugging and error checking in data processing systems. In particular, this invention relates to debugging a program by coordinating execution of multiple instances of the program.

### BACKGROUND OF THE INVENTION

A computer program has the potential to become extremely complex, particularly given today's extremely powerful hardware environments. As the computer program becomes more complex, the program can become very difficult to debug to eliminate its errors. The debugging process itself tends to be a manual process that is very time consuming, expensive, error-prone, and difficult. In fact, many errors require expertise even beyond that of the original programmer to locate and fix.

In the past, several approaches have been taken to address programs with errors. One approach included simply masking the error by adding code that inhibited an error symptom from manifesting. Masking the error, however, does not eliminate the error. The error therefore remains and may cause additional problems later. A second approach was to manually examine the source code in an attempt to find a logic error. While manual review can detect errors that are not covered by test data sets, it is also extremely time consuming and it may be nearly impossible for human programmers to understand and remember all the information needed to find and remove particularly complex errors.

Programmers have also turned to debugging programs (i.e., debuggers) in order to find and remove program errors. Generally, the debugger allowed the program to execute until a specified breakpoint was reached. The debugger then paused execution of the program. The programmer could then examine the program to determine if it was, up to that point, executing correctly. This manual approach (though assisted by the debugger) also was very time consuming, error-prone and difficult.

Therefore, a need has long existed for a program debugging technique that overcomes the problems noted above and others previously experienced.

### SUMMARY OF THE INVENTION

Methods and systems consistent with the present invention provide a mechanism for debugging programs. The methods and systems provide automated monitoring of the program and comparison of the program state. As a result, complex programs are easier to debug.

According to one aspect of the present invention, such methods and systems, as embodied and broadly described herein, include determining when and if multiple instances of a single program have reached a common break state, then initiating a comparison of state information associated with the instances. The methods and systems thereby facilitate debugging of complex programs.

Methods and systems consistent with the present invention overcome the shortcomings of the related art, for example, by allowing arbitrarily complex comparison of state information between program instances in an automated fashion. Thus, a programmer is not limited by manual examination and review of program code.

According to methods consistent with the present invention, a method is provided in a data processing system. The method includes monitoring a first instance of a program that is characterized by state information to determine when the first instance of the program reaches a predefined break state. In addition, the method waits for a second instance of the program that is characterized by its own state information to reach the predefined break state. The method then initiates execution of a state comparison program that compares the state information for each instance to determine whether the state information is indicative of correct or incorrect operation.

In accordance with systems consistent with the present invention, a data processing system is provided. The data processing system includes a memory and a processor. The memory includes a program debugger and a first instance of a program characterized by state information. The program debugger monitors the first instance to determine when the first instance reaches a predefined break state and waits for a second instance of the program (characterized by its own state information) to reach the predefined break state. The debugger then initiates execution of a state comparison program for comparing the first state information and the second state information to determine whether the first state information agrees with the second state information.

In addition, a computer-readable medium is provided. The computer-readable medium contains instructions that cause a data processing system to perform a method. The method monitors a first instance of a program (characterized by state information) to determine when the first instance of the program reaches a predefined break state. In addition, the method waits for a second instance of the program (characterized by its own state information) to reach the predefined break state. The method then initiates execution of a state comparison program for comparing the first state information and the second state information to determine whether the first state information agrees with the second state information.

Other apparatus, methods, features and advantages of the present invention will be or will become apparent to one with skill in the art upon examination of the following figures and detailed description. It is intended that all such additional systems, methods, features and advantages be included within this description, be within the scope of the present invention, and be protected by the accompanying drawings.

### BRIEF DESCRIPTION OF THE DRAWINGS

FIG. 1 depicts a block diagram of a data processing system suitable for practicing methods and implementing systems consistent with the present invention.

FIG. 2 depicts a flow diagram showing processing performed by the program debuggers running in the data processing system shown in FIG. 1 in order to determine when program instances have reached a break state and to compare their state information.

FIG. 3 depicts a flow diagram of a state comparison routine running in the data processing system shown in FIG. 1 for determining when state information for multiple program instances agrees or disagrees.

### DETAILED DESCRIPTION OF THE INVENTION

Reference will now be made in detail to an implementation in accordance with methods, systems, and products consistent with the present invention as illustrated in the accompanying drawings. The same reference numbers may be used throughout the drawings and the following description to refer to the same or like parts.

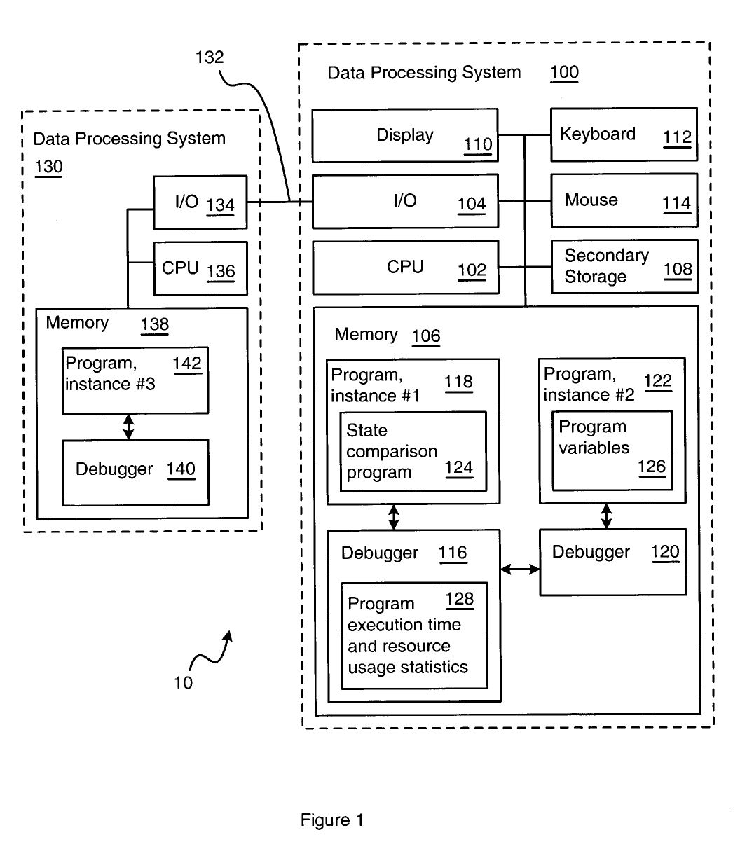

FIG. 1 depicts a block diagram 10 that includes a data processing system 100 suitable for practicing methods and implementing systems consistent with the present invention. The data processing system 100 comprises a central processing unit (CPU) 102, an input output I/O unit 104, a memory 106, a secondary storage device 108, and a video display 110. The data processing system 100 may further include input devices such as a keyboard 112, a mouse 114 or a speech processor (not illustrated).

The memory 106 includes a first debugger 116 that monitors a first instance 118 of a program. The program may be any program whose operation is under investigation (e.g., ranging from a high level spreadsheet application to a low level core operating system function or device driver). Also shown is a second debugger 120 that monitors a second instance 122 of the program. Two debuggers are not necessary. Rather, in general, a single debugger may control one or more instances of the program.

A state comparison program 124 executes out of the memory 106 to compare state information associated with each program instance 118, 122. As illustrated, the state comparison program 124 is a state comparison routine provided by the program itself. As will be explained in more detail below, the state comparison program 124 may reference program variables 126, execution time and resource usage statistics 128 for the program instances, and the like, as an aid in determining errors in the program. It is noted that the execution time and resource usage statistics 128 may be maintained by the debuggers 116, 120 or by an operating system (not shown). More generally, the state comparison program 124 may operate as a diagnostic program to determine when a program is executing in an unintended manner (e.g., by producing the wrong results, abnormally terminating, or consuming too many resources during execution) because of the influence of bugs, logic errors, and the like.

The debuggers 116, 120 and program instances 118, 122 may communicate via inter-process communication techniques (e.g., message passing, shared memory, function calls, or the like). The debuggers 116, 120 may also be in communication with a separate data processing system 130, for example over a network connection 132 (e.g., a TCP/IP Ethernet network connection) supported by the I/O unit 104. The separate data processing system 130 may be configured in a manner similar to the data processing system 100, including an I/O unit 134, a CPU 136, and a memory 138. The memory 138 includes a third debugger 140 that monitors a third instance 142 of the program. Thus, the state comparison program 124 may also compare state information for the third instance 142 received over the network connection.

Although aspects of the present invention are depicted as being stored in memory 106, one skilled in the art will appreciate that all or part of systems and methods consistent with the present invention may be stored on or read from other computer-readable media, for example, secondary storage devices such as hard disks, floppy disks, and CD-ROMs; a signal received from a network such as the Internet; or other forms of ROM or RAM either currently known or later developed. Further, although specific components of data processing system 100 are described, one skilled in the art will appreciate that a data processing system suitable for use with methods, systems, and articles of manufacture consistent with the present invention may contain additional or different components.

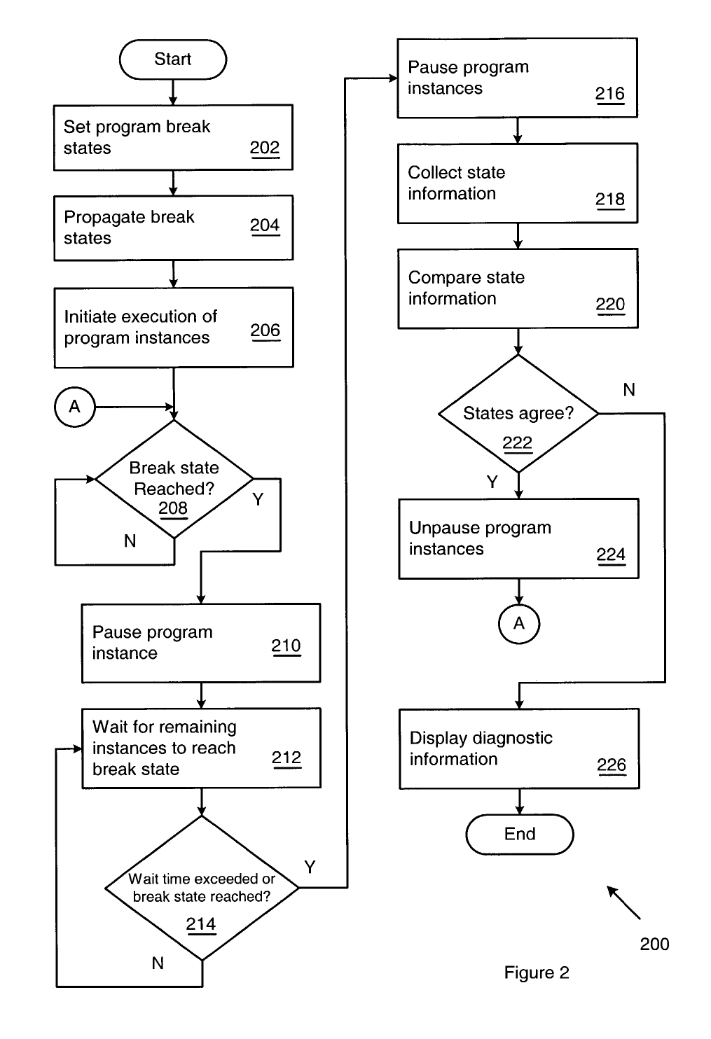

Although the discussion below proceeds specifically with reference to the debugger 116 and the first instance 118, it is noted that the discussion applies generally to all of the debuggers and program instances that may be running. With reference to the flow diagram 200 in FIG. 2, the debugger 116 (e.g., in response to operator input) sets a break state for the program (Step 202). The debugger 116 then communicates the break state to the other debuggers 120, 140 (Step 204), for example by sending a message to the debuggers 120, 140. The debugger 116 subsequently initiates execution of the first program instance (Step 206).

The break state may be formed using many different tests or criteria. As an example, a break state may be the point at which the program will next execute a specified line of code. As another example, a break state may be execution of the program for a predetermined period of time (e.g., the program will be allowed to execute for 10 seconds). As another example, the break state may be set to trigger on an allocation by the program of a particular part or size of memory. In general, the break state is a condition associated one or more program characteristics that determines when the debugger should pause the program and perform a state comparison.

The break states may be changed dynamically by the debugger 116 during execution of the first instance 118. For example, a new break state may be defined during execution, and propagated to the remaining debuggers 120, 140. Break states may thus be added, removed, or modified before or after the debuggers 116, 120, 140 initiate execution of the program instances 118, 122, 142. As the program instances 118, 122, and 142 execute, the debuggers 116, 120, and 140 monitor for occurrence of the break states (Step 208).

When, for example, the first instance 118 reaches a break state, the debugger 116 pauses execution of the first instance 118 (Step 210). The debugger 116 then waits for the remaining instances 122, 142 to reach the same break state (Step 212). For example, the debugger 116 may receive messages from the debugger 120 and debugger 140 that indicate that the second instance 122 and third instance 142 have independently reached the break state. Note that the debugger 116 may wait up to a preselected amount of time before assuming that one or more of the remaining program instances will not reach the break state. If the wait time is exceeded, the debugger 116 may then send messages to the debuggers 120, 140 to pause their program instances in preparation for a state comparison. Alternatively, the debugger 116 may immediately display an error indicator (e.g., a message window indicating that the wait time has been exceeded for one or more program instances).

The debugger 116 waits for each program instance to reach the break state or until the wait time has been exceeded (Step 214). Subsequently, the remaining program instances are paused (Step 216) and state information for each program instance is collected (Step 218). In order to collect state information, for example, the debugger 116 may receive messages from the debuggers 120, 140 that contain the state information for the program instances 122, 142. As another example, the debuggers 120, 140 may place the state information in a shared memory resource allocated in the memory 106 that is accessible to the debugger 116 or the first instance 118.

Generally, the state information represents one or more characteristics of the program instance with which it is associated. The state information is not limited to any particular form or type of information. Rather, any information that reflects upon the execution of the program may be considered when comparing state information. Table 1, below, provides many examples of state information.

TABLE 1
Exemplary State Information

| State Information | Examples |
|---|---|
| Program variables | array indices or bounds, array values, integer or |
| | floating point parameters (e.g., representing |
| | dominant frequency components in a Fast Fourier |
| | Transform), the number of elements in a list, pointer |
| | values, number of results computed, percentage of |
| | completion of a computation, loop index values |
| System state | error indicators (e.g., arithmetic indicators such as |
| | overflow, divide by zero, and the like), file locking |
| | status, file position, file size |
| Execution charac- | execution time to reach the break state, resource |
| teristics | consumption (e.g., amount of memory allocated, |
| | number of CPU registers used, CPU time used), |
| | number of cache misses (or hit rate), number of |
| | page faults, percentage of virtual memory accesses |

Once the state information has been collected, the debugger 116 initiates execution of the state comparison program 124 (Step 220). For example, the debugger 116 may set the program counter for the first instance to point to the state comparison program 124, then unpause the first instance 118. Although the state comparison program 124 is shown in FIG. 1 as a state comparison routine provided by the program itself, the state comparison may, in alternate embodiments, instead be performed by an independent program, or by the debugger 116.

The state comparison program 124 is customized to analyze elements of the state information to determine whether the state information agrees between program instances (Step 222). Thus, for example, the state comparison program may determine whether program variables that store algorithm results hold the same result among all the program instances. The state comparison program may then further determine whether the results were reached in comparable time with comparable memory usage. The state comparison program 124 is not limited by the examples above, but may perform arbitrarily complex comparisons between the state information received from each program instance.

When the state information agrees (e.g., the program instances have all reached the same result within a preselected tolerance), the debuggers unpause the program instances so that execution continues (Step 224). When the states disagree, the debuggers 116, 120, 140 display diagnostic information to that effect (Step 226). To that end, for example, the debuggers 116, 120, and 140 may open a window that displays the state information that disagrees, identify the program instances associated with the state information, and the like.

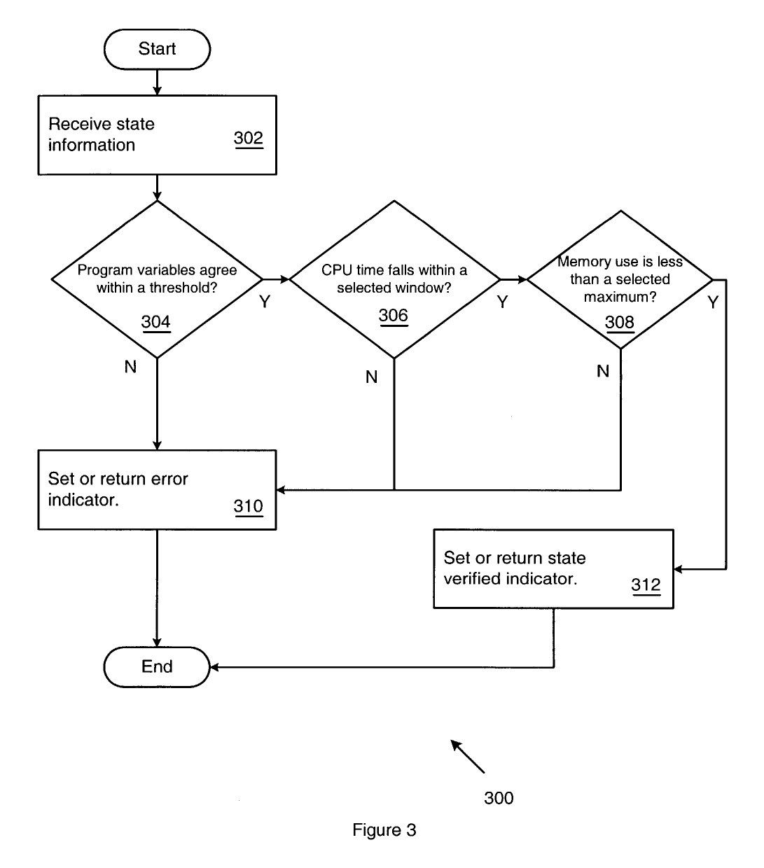

FIG. 3 provides a flow diagram 300 of the steps taken by one exemplary state comparison program. The state comparison program first receives state information for one or more program instances (Step 302). As examples, the state comparison program may receive messages that include the state information, or may access shared memory to obtain the state information. The state comparison program then analyzes the state information to determine whether the states agree.

More specifically, the state comparison program first determines whether the program variables that hold algorithm answers agree to within a preselected threshold (Step 304). Thus, the comparison program may thereby allow for small differences, for example, between number representation formats between different data processing systems. As an example, the program instance 118 and the program instance 142 may independently compute a Fast Fourier Transform (FFT) on an input data set. The state comparison program may then require the data points to agree to within 1 percent. In other words, the state comparison program may apply a threshold of 1 percent during its comparison. As another example, the program instance 118 and the program instance 142 may independently determine a predicted degree of deformation resulting from loading a mechanical structure. The state comparison program may then, for example, require the two predicted deformation values to agree to within a 5 percent threshold.

The state comparison program next determines whether the answers were obtained using an amount of CPU time that falls within a preselected window of time (Step 306). The window of time may be a differential time window that sets forth a minimum or maximum execution time difference between two or more program instances. As an example, if the first program instance is expected to reach the break state in 10 seconds, and the second program instances runs on a data processing system that is twice as slow, then the pre-selected window may be set to approximately 10 seconds. In other words, the two program instances would be expected to reach a given break state within 10 seconds of each other. The state comparison program may thereby determine when a program instance is running so slowly so that its execution speed should be investigated. Next, the state comparison program determines whether the amount of memory used to obtain the answers falls below a predetermined maximum (Step 308). As an example, in computing the degree of deformation of a mechanical structure, the amount of memory may be expected to fall below an amount that depends on the number of elements in a finite element representation of the mechanical structure.

If the state information fails any test, then the state comparison program sets or returns an error indicator (Step 310). The error indicator may, for example, be a message to the debugger 116 that includes the reason for the error, the related state information, the associated program instance, and the like. On the other hand, if the state information passes each test, then the state comparison program sets or returns a state verification indicator (Step 312). Similarly, the state verification indicator may be a message to the debugger that the states agree.

In summary, the debugger 116 determines when and if multiple instances of a program have reached a common break state, then initiates execution of the state comparison program 124. The state comparison program 124 may make arbitrarily complex comparisons of the state information. The state comparison program 124 may, for example, be customized for the program under examination to very specifically detect errors that are of greatest concern. In other words, a programmer is not limited by simple manual examination and review of program code.

It is further noted that two programs compiled from the same source code but with different compilation options or on different systems may differ in their executable code. Nevertheless, the second program may still be considered an “instance” of the first program. In other words, two program instances need not be absolutely identical before their state information can be meaningfully compared.

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. For example, the described implementation includes software but the present invention may be implemented as a combination of hardware and software or in hardware alone. Note also that the implementation may vary between systems. The invention may be implemented with both object-oriented and non-object-oriented programming systems. The claims and their equivalents define the scope of the invention.

What is claimed is:

1. A method in a data processing system, the method comprising the steps of:
monitoring a first instance of a program comprising first state information to determine when the first instance of the program reaches a predefined break state;
waiting for a second instance of the program comprising second state information to reach the predefined break state; and
initiating execution of a state comparison program for comparing the first state information and the second state information to determine whether the first state information agrees with the second state information.

2. The method of claim 1, further comprising the step of pausing the first instance of the program when the first instance reaches the predefined break state.

3. The method of claim 1, wherein the step of waiting comprises waiting until a predefined wait time is exceeded.

4. The method of claim 3, wherein the step of initiating a state comparison program comprises the step of initiating a state comparison routine in the first instance of the program.

5. The method of claim 1, wherein the step of monitoring comprises the step of monitoring with a program debugger.

6. The method of claim 5, further comprising the step of setting the predefined break state in the program debugger.

7. The method of claim 6, further comprising the steps of:
receiving a state agreement indication from the state comparison program;
setting a new predefined break state in the program debugger; and
waiting for the first instance of the program to reach the new predefined break state.

8. The method of claim 1, further comprising the steps of:
initiating execution of the first instance of the program with a first program debugger; and
initiating execution of the second instance of the program with a second program debugger.

9. The method of claim 8, wherein the second program debugger receives the second state information from the second instance and sends the second state information to the first program debugger.

10. A computer-readable medium containing instructions that cause a data processing system to perform a method comprising the steps of:
monitoring a first instance of a program comprising first state information to determine when the first instance of the program reaches a predefined break state;
waiting for a second instance of the program comprising second state information to reach the predefined break state; and
initiating execution of a state comparison program for comparing the first state information and the second state information to determine whether the first state information agrees with the second state information.

11. The computer-readable medium of claim 10, further comprising the step of pausing the first instance of the program when the first instance reaches the predefined break state.

12. The computer-readable medium of claim 10, wherein the step of initiating a state comparison program comprises the step of initiating a state comparison routine in the first instance of the program.

13. The computer-readable medium of claim 10, wherein the step of monitoring comprises the step of monitoring with a program debugger.

14. The computer-readable medium of claim 13, further comprising the step of setting the predefined break state in the debugger.

15. The computer-readable medium of claim 10, further comprising the step of initiating execution of the first instance of the program with a program debugger.

16. A data processing system comprising:
a memory comprising a program debugger and a first instance of a program comprising first state information, the program debugger for monitoring the first instance to determine when the first instance reaches a predefined break state, waiting for a second instance of the program comprising second state information to reach the predefined break state, and initiating execution of a state comparison program for comparing the first state information and the second state information to determine whether the first state information agrees with the second state information; and
a processor that runs the program debugger.

17. The data processing system of claim 16, wherein the first state information comprises program variables used by the first instance.

18. The data processing system of claim 16, wherein the first state information comprises execution time of the first instance.

19. The data processing system of claim 16, wherein the first state information comprises data processing system resource usage statistics for the first instance.

20. The data processing system of claim 16, wherein the memory further comprises a second program debugger and the second instance of the program.

21. The data processing system of claim 20, wherein the second program debugger monitors the second instance to determine when the second instance reaches the predefined break state.

22. The data processing system of claim 21, wherein the state comparison program comprises a state comparison routine in the program.

23. The data processing system of claim 22, wherein the memory further comprises third state information for a third instance of the program run externally to the data processing system until the third instance reached the predefined break state, and wherein the state comparison program compares the first state information, second state information, and third state information to determine whether the first state information, second state information, and third state information agree.

24. A data processing system comprising:
means for monitoring a first instance of a program comprising first state information to determine when the first instance of the program reaches a predefined break state;
means for waiting for a second instance of the program comprising second state information to reach the predefined break state; and
means for initiating execution of a state comparison program for comparing the first state information and the second state information to determine whether the first state information agrees with the second state information.

25. A method in a data processing system, the method comprising the steps of:
initiating execution of a first instance of a program comprising first state information;
initiating execution of a second instance of the program comprising second state information;
monitoring the first instance to determine when the first instance reaches a predefined break state, and in response, pausing execution of the first instance;
monitoring the second instance to determine when the second instance reaches the predefined break state, and in response, pausing execution of the second instance;
initiating execution of a state comparison program for comparing the first state information and the second state information to determine whether the first state information agrees with the second state information;
when the first state information agrees with the second state information, setting a new predefined break state and unpausing the first program instance and the second program instance; and
when the first state information disagrees with the second state information, displaying a first error indication.

26. The method of claim 25, further comprising the step of determining when the second instance fails to reach the predefined break state within a predetermined time, and, in response, pausing the second program instance and displaying a second error indication.

27. The method of claim 25, wherein the step of initiating a state comparison program comprises the step of initiating a state comparison routine in the first instance of the program.

28. The method of claim 25, wherein the step of monitoring the first instance comprises the step of monitoring the first instance with a program debugger, and wherein the step of monitoring the second instance comprises the step of monitoring the second instance with the program debugger.

29. The method of claim 25, wherein the step of monitoring the first instance comprises the step of monitoring the first instance with a first program debugger, and wherein the step of monitoring the second instance comprises the step of monitoring the second instance with a second program debugger.

30. A method in a data processing system having a first program, a second program and a diagnostic program, the method comprising the steps performed by the diagnostic program of:
receiving first state information indicating an execution state of the first program;
receiving second state information indicating an execution state of the second program; and
comparing the first state information and the second state information to determine whether the execution of at least one of the first and the second programs occurred in an unintended manner.

31. The method of claim 30, wherein the second program is an instance of the first program.

32. The method of claim 30, wherein the first state information comprises at least one program variable.

33. The method of claim 30, wherein the first state information comprises at least one system state characteristic.

34. The method of claim 30, wherein the first state information comprises at least one program execution characteristic.

35. The method of claim 30, wherein the step of comparing comprises the step of determining whether at least a portion of the first state information and the second state information agrees to within a predetermined threshold.

36. The method of claim 30, wherein the step of receiving the second state information comprises the step of receiving the second state information over a network connection.

37. A computer-readable medium containing instructions that cause a data processing system having a first program, a second program and a diagnostic program, to perform a method, the method comprising the steps performed by the diagnostic program of:
receiving first state information indicating an execution state of the first program;
receiving second state information indicating an execution state of the second program; and
comparing the first state information and the second state information to determine whether the execution of at least one of the first and the second programs occurred in an unintended manner.

38. The computer-readable medium of claim 30, wherein the second program is an instance of the first program.

39. The computer-readable medium of claim 30, wherein the first state information comprises at least one program variable.

40. The computer-readable medium of claim 30, wherein the first state information comprises at least one system state characteristic.

41. The computer-readable medium of claim 30, wherein the first state information comprises at least one program execution characteristic.

42. The computer-readable medium of claim 30, wherein the step of comparing comprises the step of determining whether at least a portion of the first state information and the second state information agrees to within a predetermined threshold.

43. The computer-readable medium of claim 30, wherein the step of receiving the second state information comprises the step of receiving the second state information over a network connection.

44. The computer readable-medium of claim 30, further comprising the step of receiving third state information indicating an execution state of a third program, and wherein the step of comparing comprises the step of comparing the first state information, the second state information, and the third state information to determine whether the execution of at least one of the first, second, and third programs occurred in an unintended manner.

45. The computer-readable medium of claim 37, wherein the second program and the third program are instances of the first program.
